(19) United States
(12) Patent Application Publication
(10) Pub. No.: US 2006/0045651 A1
(43) Pub. Date: Mar. 2, 2006

(54) Expandable screw cover

(75) Inventors: Ming-Feng Ma, Shenzhen (CN); Rui-Hao Chen, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 10/949,476

(22) Filed: Sep. 24, 2004

(30) Foreign Application Priority Data
Sep. 1, 2004 (TW) 93200361

(51) Int. Cl. F16B 1/00

(52) U.S. Cl. 411/372.6

(57) ABSTRACT

A screw cover (100) for a screw hole (32) includes a stretchable cap (10), and a post (20) movably engaged therein. The cap includes an end (12) having an opening (122) and three arms (14) extending therefrom. The arms have three longitudinal slits (144) therebetween. The post has two wedges (242) slidably engaged in two of the slits. A diameter of the cap is no larger than a diameter of the screw hole, and a diameter of the post is larger than a diameter of the opening. In use, the post is interferingly inserted into the opening and enlarges the cap, which engages the screw cover in the screw hole. In removal, the post is released from the opening, and the cap returns to its original size. The screw cover can then be easily removed from the screw hole. Attachment and removal of the screw cover is easy and safe.

### BACKGROUND OF THE INVENTION

1. Field of the Invention

The present invention generally relates to screw covers, and more particularly to a screw cover for a portable electronic device.

2. Prior Art

Currently, screw covers are widely used in electronic apparatuses including portable electronic devices in order to keep screws hidden. An example is found in the mobile phone model no. N188 marketed by Samsung Company. The mobile phone includes a columnar screw cover. The screw cover is made of plastic, and is set in a screw hole over a screw. The diameter of the screw cover is slightly greater than that of the screw hole, so that the screw cover blocks the screw from accidentally coming out from the screw hole. However, in removing the screw cover, it is difficult to prize the screw cover out from the screw hole without a tool. Furthermore, the tool is generally made of rigid material, and the screw cover can be easily damaged or even destroyed when it is removed.

Therefore, a screw cover which is easily and safely attached and removed is desired.

### SUMMARY OF THE INVENTION

Accordingly, an object of the present invention is to provide a screw cover which is readily attached in and readily and safely removed from a screw hole.

To achieve the above-mentioned object, a screw cover for covering a screw in a screw hole includes a cap made of stretchable material, and a post movably engaged in the cap. The cap includes an end having a round opening, and arms extending from the end thereof defining at least one longitudinal slit therein. The post has at least one wedge extending in a transverse direction, slidably engagable in said slit of the cap. A diameter of the cap is the same as or less than a diameter of the screw hole, and a diameter of the post is larger than a diameter of the opening. In use of the screw cover, the post in interferingly inserted into the opening, and the diameter of the cap is enlarged whereby the screw cover can be engaged in the screw hole. In removal of the screw cover from the screw hole, the post is released from the opening, and the diameter of the cap returns to its original size. The screw cover can then be easily removed from the screw hole. The screw cover utilizes the interengaging structures of the cap and the post and the elasticity of the cap in a way that makes attachment and removal of the screw cover quick, convenient and safe.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a screw cover in accordance with a preferred embodiment of the present invention, the screw cover comprising a central post received in an outer cap;

FIG. 2 is an exploded, isometric view of the screw cover of FIG. 1, viewed from another aspect;

FIG. 3 is essentially a cross-sectional view of the screw cover of FIG. 1 secured in a corresponding part of a mobile phone, showing the post engaged with the cap; and

FIG. 4 is similar to FIG. 3, but showing the post disengaged from the cap.

### DETAILED DESCRIPTION OF THE INVENTION

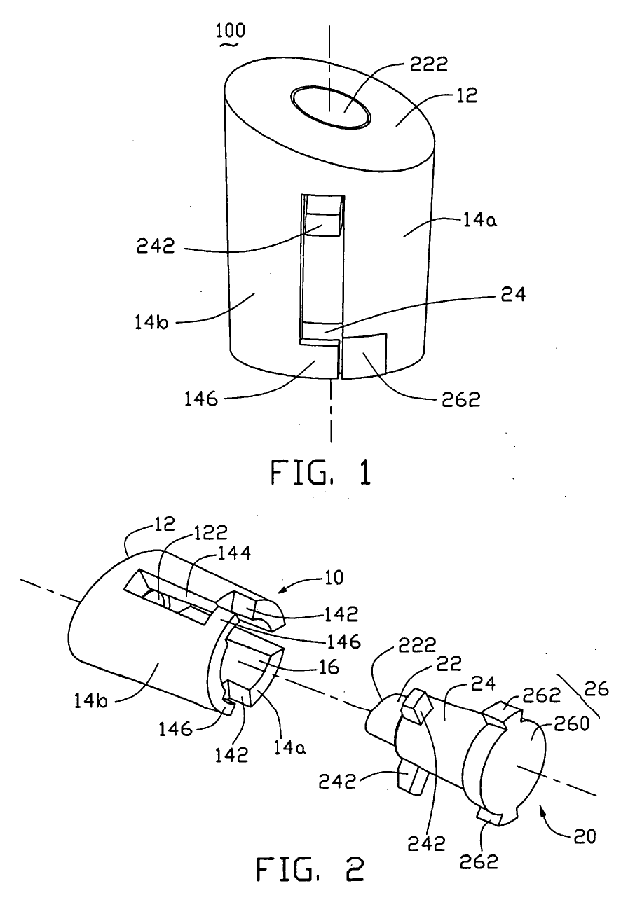

Referring to FIGS. 1 and 2, a screw cover 100 in accordance with the preferred embodiment of the present invention includes a cap 10 made from a kind of stretchable material such as plastic, and a post 20. The cap 10 is a hollow cylinder. The post 20 is contained in the cap 10, with the cap 10 and the post 20 being coaxial.

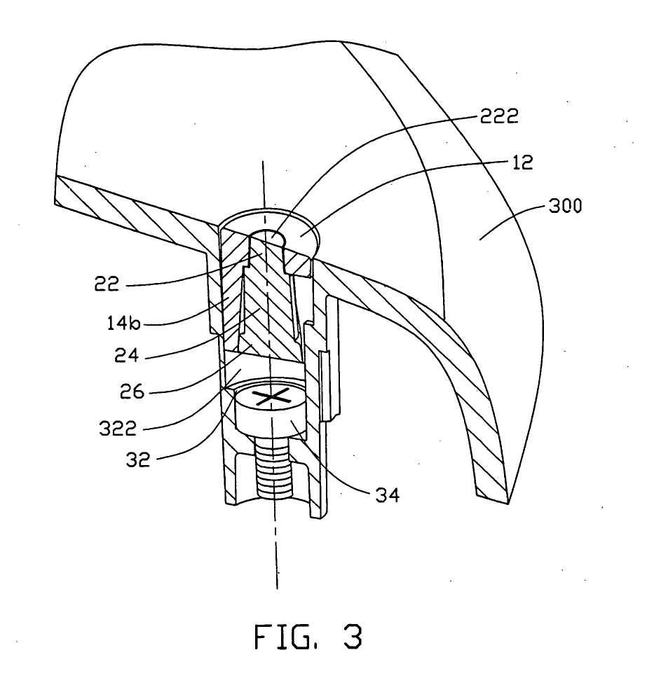

Referring also to FIG. 3, the cap 10 includes an end 12 with a round opening 122 therein, three arms 14 extending from the end 12, and a cylindrical chamber 16 cooperatively defined by the end 12 and the arms 14. A diameter of the end 12 is slightly less than or the same as a diameter of a screw hole 32 of a mobile phone 300. Three longitudinal slits 144 are defined between the three arms 14 respectively. Two of the three arms 14 are designated as arms 14a. Each arm 14a defines a recess 142 distal from the end 12. The recesses 142 are approximately opposite each other across the chamber 16. The third of the three arms 14 is designated as an arm 14b. The arm 14b comprises two paws 146 distal from the end 12. The paws 146 are at opposite sides of a main body of the arm 14b, and are adjacent the recesses 142 respectively.

The post 20 includes a base 26, a middle column 24 extending from the base 26, and a top column 22 extending from the middle column 24. The base 26, the middle column 24, and the top column 22 are coaxial. The base 26 includes a main body 260, and two wedges 262 extending approximately from opposite sides of the main body 260 respectively. A diameter of the main body 260 is slightly greater than a diameter of the chamber 16. A diameter of the middle column 24 is less than the diameter of the main body 260, and greater than a diameter of the opening 122. The middle column 24 defines two wedges 242 distal from the base 26, at positions corresponding to the two slits 144 that are between the arm 14b and the arms 14a. The top column 22 includes an exposed surface 222. A diameter of the top column 22 is less than the diameter of the middle column 24, thereby defining a step at the middle column 24. The diameter of the top column 22 is slightly greater than the diameter of the opening 122.

Referring to FIGS. 1 and 3, to attach the screw cover 100 in the screw hole 32 of the mobile phone 300, firstly, the post 20 is attached to the cap 10 as follows. The top column 22 is interferingly fixed in the opening 122, the wedges 242 are slidably engaged in the corresponding slits 144 via the recesses 142, and the wedges 262 are received in the recesses 142. Thus the post 20 is neatly and firmly surrounded by the cap 10, with the post 20 and the cap 10 being coaxial. The end 12 is expanded to be slightly larger than its original size, and the arms 14 are slightly splayed out and resiliently hold the post 20. Accordingly, an outer diameter of the cap 10 is uniformly slightly larger than the diameter of the screw hole 32 of the mobile phone 300. Thus the screw cover 100 can be interferingly and securely fixed in the screw hole 32 over a screw 34, with the base 26 of the post 20 facing the screw 34. A space 322 is defined between the screw cover 100 and the screw 34.

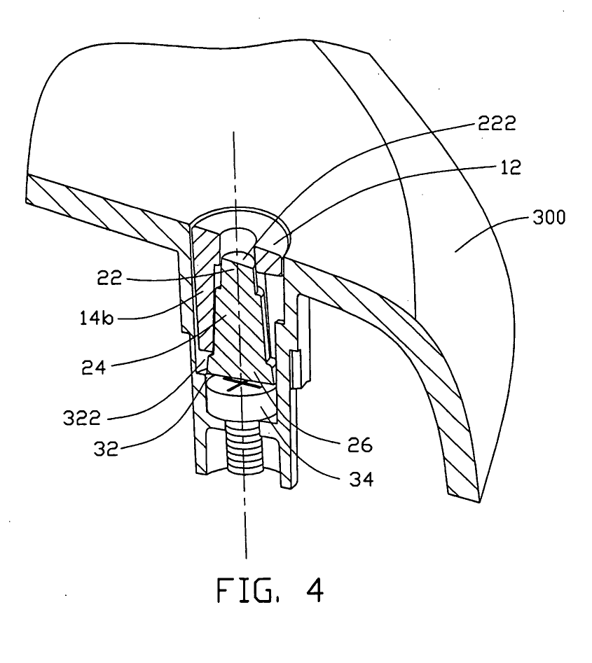

Referring to FIG. 4, to remove the screw cover 100 from the screw hole 32, firstly the top column 22 is pressed down so that it is disengaged from the opening 122. Simultaneously, the post is partly received in the space 322, the wedges 262 are disengaged from the recesses 142, the outer diameter of the cap 10 returns to its original size (which is smaller than the diameter of the screw hole 32), and the wedges 242 slide along but remain in the corresponding slits 144. The post 20 remains loosely connected to the cap 10 through the wedges 242. The mobile phone 300 is then inverted, and the combined cap 10 and post 20 can easily drop out from the screw hole 32. Because the screw cover 100 remains intact as a single item, it is not easily lost.

From the above description, it can be seen that the screw cover 100 utilizes the interengaging structures of the cap 10 and the post 20 and the elasticity of the cap 10 in a way that makes attachment and removal of the screw cover 100 quick, convenient and safe.

It is to be understood that in alternative embodiments, the opening 122 of the cap 10 can have various shapes other than being round. Further, the recesses 142 can be omitted. In such case, the arms 14 are interconnected with each other distal from the end 12. When the post 20 is attached to the cap 10, the arms 14 are elastically deformed to enable the wedges 242 to snap into the corresponding slits 144.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A screw cover for covering a screw in a screw hole, comprising:
a cap made of stretchable material, comprising an end having a opening, and a wall extending from the end thereof, the wall defining at least one longitudinal slit therein; and
a post engaged in the cap, and comprising at least one first wedge extending in a transverse direction, said wedge slidably engagable in said slit of the cap; wherein a diameter of the cap is the same as or less than a diameter of the screw hole, and a diameter of the post is larger than a diameter of the opening;
in use of the screw cover, the post is inserted into the opening and enlarges the diameter of the opening, and the diameter of the cap is enlarged whereby the screw cover can be engaged in the screw hole; and
in removal of the screw cover from the screw hole, the post is released from the opening, and the diameters of the opening and the cap return to their original sizes.

2. The screw cover as claimed in claim 1, wherein the post comprises a top column and a middle column extending from one end of the top column, a diameter of the top column is larger than the diameter of the opening, and a diameter of the middle column is larger than a diameter of the top column thereby defining a step thereat.

3. The screw cover as claimed in claim 2, wherein said first wedge is formed on the middle column.

4. The screw cover as claimed in claim 1, wherein the wall defines a chamber therein, and a diameter of the chamber is larger than the diameter of the post.

5. The screw cover as claimed in claim 4, wherein the post comprises a top column and a middle column extending from one end of the top column, a diameter of the top column is larger than the diameter of the opening, and a diameter of the middle column is larger than a diameter of the top column thereby defining a step surface thereat.

6. The screw cover as claimed in claim 5, wherein said first wedge is formed on the middle column.

7. The screw cover as claimed in claim 4, wherein the wall comprises at least two arms for receiving and holding the post, and said slit is defined between the arms.

8. The screw cover as claimed in claim 7, wherein each of the arms defines a recess, the post further comprises a base which comprises a main body and at least two second wedges extending from the main body, and the second wedges are received in the recesses.

9. The screw cover as claimed in claim 7, wherein the post comprises a top column and a middle column extending from one end of the top column, a diameter of the top column is larger than the diameter of the opening, and a diameter of the middle column is larger than a diameter of the top column, thereby defining a step surface thereat.

10. The screw cover as claimed in claim 9, wherein said first wedge is formed on the middle column.

11. The screw cover as claimed in claim 9, wherein each of the arms defines a recess, the post further comprises a base which comprises a main body and a least two second wedges extending from the main body, and the second wedges are received in the recesses.

12. The screw cover as claimed in claim 11, wherein a diameter of the base is larger than the diameter of the middle column, and larger than the diameter of the chamber.

13. A combination of a screw installation structure, comprising:
a hole defined at a surface of a housing;
a screw located at a bottom end of the hole;
a screw cover disposed in the hole and including:
a center piece engageably surrounded by a circumferential piece; wherein said center piece has at least a wedge slidably contained in at least a slit of said circumferential piece; and
when said center piece is located in a first position relatively close to the surface of the housing, the screw cover essentially provides a top face flush with the surface of the housing and the circumferential piece is urged by the center piece to interfere with an interior surface of the hole for retaining the screw cover in position in the hole; and when said center piece is located in a second position relatively far from the surface of the housing, the circumferential piece is released from the center piece and thus no longer interferes with the interior surface of the hole so as to allow the screw cover to removed from the hole, while the center piece is still retained in said circumferential piece by the engagement of said wedge in said slit.

14. The combination as claimed in claim 13, wherein said center piece and said circumferential piece are discrete from each other.

15. A method of covering a screw on a housing wherein said housing defines a hole extending inwardly from a surface thereof and said screw is located under said surface, comprising the step of:
providing a first piece movably connected with a second piece to commonly form a screw cover to be received in the hole above said screw;
wherein said second piece is urged by the first piece to be retainably engaged with an interior surface of the hole when said first piece is located in a first position along an axial direction of the hole; and said second piece is released from said first piece so as not to be retainably engaged with the interior surface of the hole when said first piece is located in a second position along said axial direction of the hole, thereby allowing the screw cover to be removed from the hole while at the same time the first piece remains connected to the second piece.

16. The method as claimed in claim 15, wherein said second piece surrounds said first piece.

17. The method as claimed in claim 15, wherein said first position is closer to the surface than said second position.

18. The method as claimed in claim 15, wherein said first piece and said second piece are discrete from each other.

19. The method as claimed in claim 15, wherein said second piece interferes with the interior surface of said hole when said first piece is located in said first position.

20. The method as claimed in claim 15, wherein said first piece interferes with said second piece when said first piece is located in said first position.
